(19) United States
(12) Patent Application Publication
(10) Pub. No.: US 2012/0239574 A1
(43) Pub. Date: Sep. 20, 2012

(54) METHODS AND SYSTEMS FOR ELECTRONIC COMMERCE VERIFICATION

(76) Inventors: Janet Smith, Des Peres, MO (US); Johan Gerber, Wildwood, MO (US); Clara Salazar, Ballwin, MO (US)

(21) Appl. No.: 13/421,976

(22) Filed: Mar. 16, 2012

Related U.S. Application Data
(60) Provisional application No. 61/454,361, filed on Mar. 18, 2011.

(51) Int. Cl. G06Q 20/40

(52) U.S. Cl. 705/44

(57) ABSTRACT

A computer system for fraud detection in a payment card transaction system is provided. The computer system is programmed to receive a card transaction authorization request message for a payment card transaction initiated with a merchant that includes a plurality of data elements to be verified and a verification request indicator, determine whether the verification request indicator is valid, transmit the request message and verification request indicator to an issuer associated with the payment card, and receive a card transaction authorization response message from the issuer that includes an issuer authorization decision and a verification indicator associated with each data element verified by the issuer. The verification indicator indicates a status of a verification of the data element with data stored in one or more databases of the issuer. The computer system is further programmed to transmit the card transaction authorization response message to the merchant.

### CROSS REFERENCE TO RELATED APPLICATIONS

This application claims the benefit of U.S. Provisional Patent Application No. 61/454,361 filed Mar. 18, 2011, which is hereby incorporated by reference in its entirety.

### BACKGROUND OF THE INVENTION

This invention relates generally to payment card networks and, more particularly, to network-based methods and systems for providing verification of cardholder information submitted as part of payment card transactions including card-not-present (CNP) transactions.

Merchants are faced with lost revenue and significant costs for fraudulent transactions. At least some known merchants address the problem through either increased headcount for manually reviewing orders or using an automated screening service. There is a growing web fraud detection market with companies offering automated tools to merchants for managing their risk of fraud. More and more, merchants are implementing these third-party web fraud detection services. A few of the larger, more sophisticated merchants have built their own tools.

Merchants are challenged to detect more sophisticated fraud attempts by users posing as consumers and looking to commit fraud. These challenges increase when the merchants grow their online sales operations. To detect fraud, a variety of data points from the transaction and the ordering device itself are reviewed for anomalies or inconsistencies. Moreover, merchants manage their order review and fraud detection by manually flagging and checking high risk orders, using automated screening, rules-based tools, using fraud detection tools developed in-house, and using tools licensed from third-party fraud detection vendors. Although merchants do have access to past cardholder history on their site, they do not have access to is the total view of the cardholder's online and offline history across multiple merchants.

Accordingly, a computer implemented method and system are needed that enables a merchant to better confirm the identity of a transaction card user as the identity of the person that the transaction card was actually issued to by the issuing bank, especially in the case of card-not-present (CNP) transactions.

### BRIEF DESCRIPTION OF THE INVENTION

In one aspect, a computer system for fraud detection in a payment card transaction system is provided. The computer system includes a memory device for storing data, and a fraud detection computer system comprising a processor. The processor is in communication with the memory device. The computer system is programmed to receive a card transaction authorization request message for a payment card transaction initiated with a merchant wherein the card transaction authorization request message includes a plurality of data elements to be verified and a verification request indicator, determine whether the verification request indicator is valid, transmit the card transaction authorization request message and verification request indicator to an issuer associated with the payment card used in the transaction, and receive a card transaction authorization response message from the issuer wherein the card transaction authorization response message includes an issuer authorization decision and a verification indicator associated with each data element verified by the issuer. The verification indicator indicates a status of a verification of the data element with data stored in one or more databases of the issuer. The computer system is further programmed to transmit the card transaction authorization response message to the merchant.

In another aspect, a method of detecting fraud in a payment card transaction is provided. The method uses a fraud detection computing device in communication with a memory device. The method includes receiving, at the fraud detection computing device, a card transaction authorization request message for a payment card transaction initiated with a merchant wherein the card transaction authorization request message including a plurality of data elements to be verified and a verification request indicator, determining whether the verification request indicator is valid, transmitting the card transaction authorization request message and verification request indicator to an issuer computing device wherein the issuer computing device associated with an issuer bank having issued the payment card used in the transaction, and receiving a card transaction authorization response message from the issuer computing device. The card transaction authorization response message includes an issuer authorization decision and a verification indicator associated with each data element verified by the issuer. The verification indicator indicates a status of a verification of the data element with data stored in one or more databases of the issuer. The method further includes transmitting the card transaction authorization response message to the merchant.

In another aspect, at least one non-transitory computer-readable storage media having computer-executable instructions embodied thereon is provided. When executed by at least one processor, the computer-executable instructions cause the processor to receive a card transaction authorization request message for a payment card transaction initiated with a merchant wherein the card transaction authorization request message includes a plurality of data elements to be verified and a verification request indicator, determine whether the verification request indicator is valid, transmit the card transaction authorization request message and verification request indicator to an issuer associated with the payment card used in the transaction, and receive a card transaction authorization response message from the issuer wherein the card transaction authorization response message includes an issuer authorization decision and a verification indicator associated with each data element verified by the issuer. The verification indicator indicates a status of a verification of the data element with data stored in one or more databases of the issuer. The computer-executable instructions further cause the processor to transmit the card transaction authorization response message to the merchant.

In another aspect, a computer system for detecting fraud in a payment card transaction includes a memory device for storing data and a fraud detection computer system including a processor wherein the processor is in communication with the memory device and wherein the computer system is programmed to receive a card transaction authorization request message from a merchant through an acquirer for a payment card transaction. The card transaction authorization request message including a plurality of data elements to be verified and an ecommerce verification service request indicator. The computer system is further programmed to determine whether the ecommerce verification service request indicator is valid, and to transmit the card transaction authorization request message and ecommerce verification service request indicator to an issuer associated with the payment card used in the transaction. The computer system is further programmed to receive a card transaction authorization response message from the issuer including an issuer authorization decision and a verification indication associated with each data element that was verified by the issuer wherein the verification indication indicates a status of a verification of the data element with data stored in one or more databases of the issuer, and to transmit the card transaction authorization response message to the merchant through the acquirer.

The verification indication can include a determination of at least one of a match of the transmitted data element with a respective data element stored in the one or more databases of the issuer, a no-match of the transmitted data element with a respective data element stored in the one or more databases of the issuer, and a not-available response. The computer system may be further programmed to receive a card transaction authorization request message from a card-not-present transaction or a card present transaction. Moreover, the plurality of data elements to be verified can include at least one of a cardholder name, a cardholder home phone number, a cardholder work phone number, a cardholder mobile phone number, a cardholder email address, a cardholder IP address, a cardholder street address, a cardholder device ID, a ship-to address, and a merchant risk assessment.

In another aspect, a method of detecting fraud in a payment card transaction includes receiving a card transaction authorization request message from a merchant through an acquirer for a payment card transaction, the card transaction authorization request message including a plurality of data elements to be verified and an ecommerce verification service request indicator, determining whether the ecommerce verification service request indicator is valid, transmitting the card transaction authorization request message and ecommerce verification service request indicator to an issuer associated with the payment card used in the transaction, receiving a card transaction authorization response message from the issuer wherein the card transaction authorization response message includes an issuer authorization decision and a verification indication associated with each data element that was verified by the issuer and wherein the verification indication indicates a status of a verification of the data element with data stored in one or more databases of the issuer, and transmitting the card transaction authorization response message to the merchant through the acquirer.

In still another aspect, one or more non-transitory computer-readable storage media includes computer-executable instructions embodied thereon, wherein when executed by at least one processor, the computer-executable instructions cause the processor to receive a card transaction authorization request message from a merchant through an acquirer for a payment card transaction, determine whether the ecommerce verification service request indicator is valid, transmit the card transaction authorization request message and ecommerce verification service request indicator to an issuer associated with the payment card used in the transaction, receive a card transaction authorization response message from the issuer, and transmit the card transaction authorization response message to the merchant through the acquirer. The card transaction authorization request message can include a plurality of data elements to be verified and an ecommerce verification service request indicator, and the card transaction authorization response message can include an issuer authorization decision and a verification indication associated with each data element that was verified by the issuer wherein the verification indication indicates a status of a verification of the data element with data stored in one or more databases of the issuer.

### BRIEF DESCRIPTION OF THE DRAWINGS

FIGS. 1-7 show exemplary embodiments of the method and system described herein.

FIG. 1 is a schematic diagram illustrating an exemplary multi-party payment card industry system for enabling ordinary payment-by-card transactions in which merchants and card issuers do not necessarily have a one-to-one relationship.

FIG. 2 is a simplified block diagram of an exemplary payment card account system having an Ecommerce Verification System (EVS) in accordance with one embodiment of the present invention.

FIG. 3 is an expanded block diagram of an exemplary embodiment of a server architecture of the payment card account system shown in FIG. 2.

FIG. 4 illustrates an exemplary configuration of a cardholder computer device operated by a cardholder.

FIG. 5 illustrates an exemplary configuration of a server computer device such as the server system shown in FIGS. 2 and 3.

FIG. 6 is a simplified data flow block diagram of an exemplary payment card account system having an Ecommerce Verification System (EVS) in accordance with one embodiment of the present invention.

FIG. 7 is a simplified data flow block diagram of an alternative embodiment of the payment card account system having an EVS that is accessible by a web call.

### DETAILED DESCRIPTION OF THE INVENTION

Embodiments of the methods and systems described herein include a payment card account system having an Ecommerce Verification Module (EVM) (referred to herein collectively as the “EVM payment card system”) that enables the system to offer an Ecommerce Verification Service (EVS). Through this EVM payment card system, a merchant submits a request to an issuer to validate cardholder information. The merchant transmits cardholder information to the issuer, the issuer verifies the transmitted cardholder information with their information contained in the issuer's cardholder database, and responds back to the merchant with a verification indication such as, but not limited to, a “match”, a “no-match”, or a “not-available” response. In other cases, an acquirer and/or another third party submits the request to the payment card account system, which in turn transmits it to the issuer for data verification.

In an alternative embodiment, at least one of a merchant, an acquirer and some other third party submits a request to the payment card account system with data to be verified, wherein the payment card account system includes an open application programming interface (Open API). By having an Open API, the merchant, the acquirer and/or the other third party are able to submit the request (also referred to in this case as a “web call”) over a network, such as the Internet, to the payment card account system. The payment card account system is then able to convert the web call request into a payment card authorization request message, which is then communicated to the issuer for data verification. The issuer responds back with an authorization response message as discussed below, and the payment card account system converts that message into a web call response that is sent to the party that originated the web call request.

In another embodiment, the payment card account system either (i) performs the data verification itself using data stored within a database associated with the payment card account system and does not transmit a data verification request to the issuer as part of an authorization request message, or (ii) transmits the data verification request message to a third party, other than the issuer (e.g., credit rating entity), for data verification wherein the third party stores information relating to cardholders. The payment card account system or the third party verifies the information provided by the merchant or other party with a verification indication such as, but not limited to, a “match”, a “no-match”, or a “not-available” response.

Although described in conjunction with a card-not-present (CNP) transaction, the EVM payment card system is also able to be used for card present transactions. Specifically, an example of CNP transactions includes payment transactions that use transaction card information stored by a merchant and wherein the transaction card is not present for the actual transaction. For example, a health club member may wish to avoid mailing a monthly check for club membership dues. The member may instead register a transaction card, such as a credit card, a debit card, or a prepaid card, with the club, enabling the club to automatically charge the transaction card for the monthly dues on a particular day each month. In some such systems, the merchant stores an account number, an expiration date, and/or other information associated with the transaction card and/or cardholder. Other examples of CNP transactions include telephone initiated transactions, postal mail transactions, or ecommerce or Internet transactions where the merchant does not have transaction card information stored or available and the merchant may not have a prior relationship with the purchaser at all. In such cases, the merchant receives the transaction card information at the time of the transaction.

In the example embodiment, the EVM payment card system functions as part of a normal authorization of a transaction using a network interface processor. However, the EVS may also be used to verify information not associated with a current transaction. For example, a merchant may wish to verify data associated with a perspective customer or past customer. In one embodiment, the merchant may initiate a transaction authorization using a “$0.00” amount. In another embodiment, the merchant may initiate a transaction authorization using any transaction amount but, does not complete the transaction when the authorization response is returned to the merchant. In various embodiments, the EVM payment card system functions as an enhanced service funded on a subscription basis and may not operate on all transactions, but rather, may function on only transactions received from subscribed merchants. In various other embodiments, the EVM payment card system only functions on a transaction-by-transaction basis as requested by any merchant during the authorization request process. Specifically, the merchant transmits a card transaction authorization request message, which includes a plurality of data elements, to an acquirer and indicates the EVS is also being requested. The merchant populates the data elements that are requested to be validated by the issuer. The data elements that the merchant transmits to the issuer for validation/verification include but are not limited to, cardholder name, cardholder phone number(s); including for example, a home phone number, a work phone number and/or a cell phone number, an email address, an IP address, a street address, a device ID, a ship-to address, a merchant risk assessment, and other data.

The acquirer populates a CNP ecommerce verification service request indicator within the card transaction authorization request message and submits the card transaction authorization request message to a network interface processor.

The network interface processor identifies if the ecommerce verification service indicator is present and validates that the issuer supports the ecommerce verification service. The card transaction authorization request message is routed on to the network interface processor.

The issuer receives the card transaction authorization request message, identifies the ecommerce verification service indicator is present and validates the EVS data points by comparing information provided by the merchant with the issuer cardholder database. The issuer appends a verification indication to each of the data elements provided by the merchant within a card transaction authorization request response message. The verification indication includes for example, but is not limited to “match”/“no match” or “not available.”

The network interface processor routes the card transaction authorization request response message to the acquirer, including a card issuer authorization decision and ecommerce verification service verification indications.

The acquirer receives the card transaction authorization request response message with ecommerce verification service verification indications provided by the issuer. The acquirer transmits card transaction authorization request response message to the merchant. The merchant determines whether to complete the transaction based at least in part on the card issuer authorization decision and ecommerce verification service verification indications included within the card transaction authorization request response message.

The following detailed description illustrates embodiments of the invention by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. The disclosure is described as applied to an exemplary embodiment, namely, systems and methods of validating cardholder information through the payment card network for merchants in a payment card network. However, it is contemplated that this disclosure has general application to computing systems in industrial, commercial, and residential applications.

As used herein, an element or step recited in the singular and preceded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

Embodiments of the present invention described herein relate to validating cardholder information through the payment card network for merchants in payment card transactions, such as, card-not-present payment card transactions.

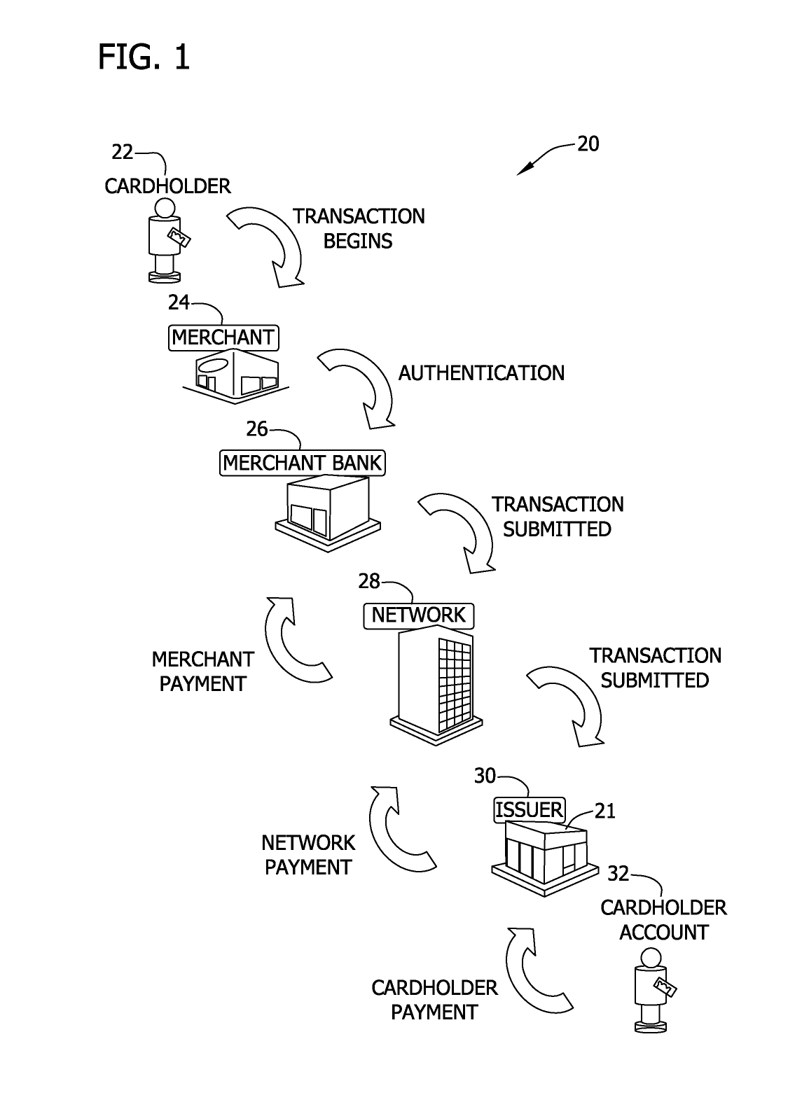

FIG. 1 is a schematic diagram 20 illustrating an exemplary multi-party payment card industry system for enabling ordinary payment-by-card transactions in which merchants and card issuers do not necessarily have a one-to-one relationship. The present invention relates to a payment card system, such as a credit card payment system using the MasterCard® payment system. The MasterCard® payment system is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In a typical payment card system, a financial institution such as an issuer 21 issues a payment account card, such as a credit card account or a debit card account, to a cardholder 22, who uses the payment account card to tender payment for a purchase from a merchant 24. To accept payment with the payment account card, merchant 24 must normally establish an account with a financial institution that is part of the financial payment system. This financial institution is usually called the “merchant bank” or the “acquiring bank” or “acquirer bank.” When a cardholder 22 tenders payment for a purchase with a payment account card (also known as a financial transaction card), merchant 24 requests authorization from merchant bank 26 for the amount of the purchase. The request may be performed over the telephone, but is usually performed through the use of a point-of-sale terminal, which reads the cardholder's account information from the magnetic stripe on the payment account card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor” or an “acquiring processor.”

Using a network interface processor 28, the computers of the merchant bank or the merchant processor will communicate with the computers of issuer 30 to determine whether the cardholder's account is in good standing and whether the purchase is covered by the cardholder's available credit line or account balance. Based on these determinations, the request for authorization will be declined or accepted. If the request is accepted, an authorization code is issued to merchant 24.

When a request for authorization is accepted, the available credit line or available balance of cardholder's account 32 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 24 captures the transaction by, for example, appropriate data entry procedures on the point-of-sale terminal. If a cardholder cancels a transaction before it is captured, a “void” is generated. If a cardholder returns goods after the transaction has been captured, a “credit” is generated.

For debit card transactions, when a request for a PIN authorization is approved by the issuer, the cardholder's account 32 is decreased. Normally, a charge is posted immediately to cardholder's account 32. The bankcard association then transmits the approval to the acquiring processor for distribution of goods/services, or information or cash in the case of an ATM.

After a transaction is captured, the transaction is settled between merchant 24, merchant bank 26, and issuer 30. Settlement refers to the transfer of financial data or funds between the merchant's account, merchant bank 26, and issuer 30 related to the transaction. Usually, transactions are captured and accumulated into a “batch,” which is settled as a group.

Financial transaction cards or payment account cards can refer to credit cards, debit cards, and prepaid cards. These cards can all be used as a method of payment for performing a transaction. As described herein, the term “financial transaction card” or “payment account card” includes cards such as credit cards, debit cards, and prepaid cards, but also includes any other devices that may hold payment account information, such as mobile phones, personal digital assistants (PDAs), and key fobs.

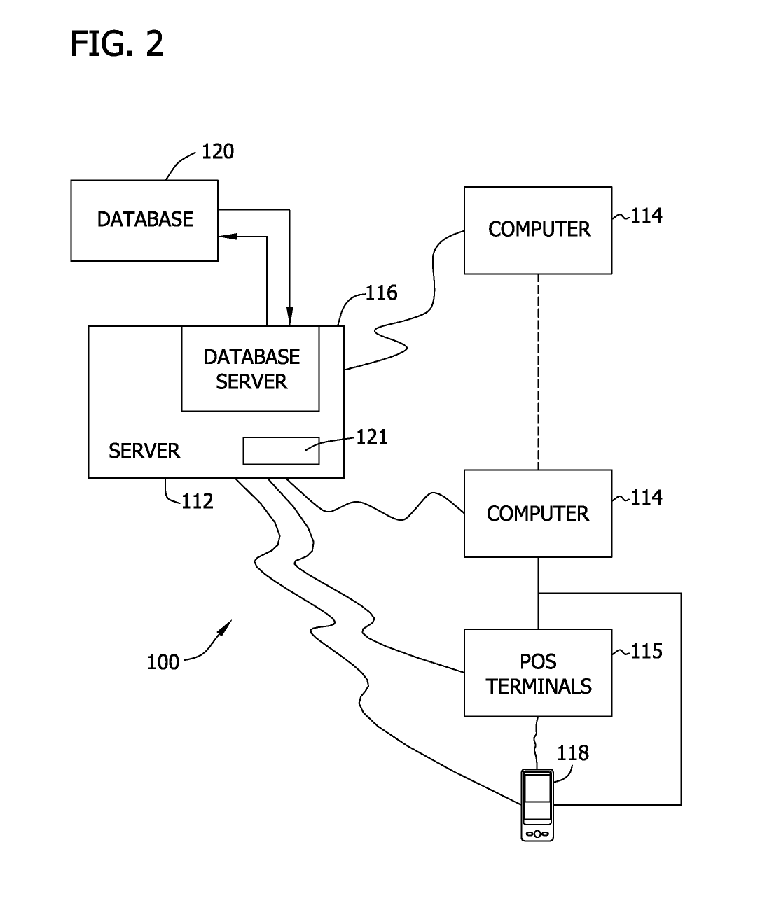

FIG. 2 is a simplified block diagram of an exemplary payment card account system 100 having an Ecommerce Verification Module (EVM) and offering an Ecommerce Verification Service (EVS) in accordance with one embodiment of the present invention. System 100 is a payment card account system, which can be utilized by account holders as part of a process of initiating an authorization request and performing a transaction as described below.

More specifically, in the example embodiment, system 100 includes a server system 112, which is a type of computer system, and a plurality of client sub-systems (also referred to as client systems 114) connected to server system 112. In one embodiment, client systems 114 are computers including a web browser and a memory device, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed ISDN lines. Client systems 114 could be any device capable of interconnecting to the Internet including a web-based phone, personal digital assistant (PDA), or other web-based connectable equipment.

System 100 also includes point-of-sale (POS) terminals 115, which are connected to client systems 114 and may be connected to server system 112. POS terminals 115 are interconnected to the Internet through many interfaces including a network, such as a local area network (LAN) or a wide area network (WAN), dial-in-connections, cable modems, wireless modems, and special high-speed ISDN lines. POS terminals 115 could be any device capable of interconnecting to the Internet and including an input device capable of reading information from a cardholder's financial transaction card.

A database server 116 is connected to database 120, which contains information on a variety of matters, as described below in greater detail. In one embodiment, centralized database 120 is stored on server system 112 and can be accessed by cardholders at one of client systems 114 by logging onto server system 112 through one of client systems 114. In an alternative embodiment, database 120 is stored remotely from server system 112 and may be non-centralized. Database 120 may store transaction data generated as part of sales activities conducted over the bankcard network including data relating to merchants, account holders or customers, and purchases. Database 120 may also store account data including at least one of a cardholder name, a cardholder address, an account number, and other account identifiers. Database 120 may also store merchant data including a merchant identifier that identifies each merchant registered to use the payment account card network, and instructions for settling transactions including merchant bank account information.

In one embodiment, an Ecommerce Verification Module (EVM) 121 is stored on server system 112. EVM 121 enables system 100 to offer the Ecommerce Verification Service, which includes a merchant submitting a request to an issuer to validate cardholder information. Specifically, the merchant transmits cardholder information to the issuer through the EVM, the issuer verifies the transmitted cardholder information with their information contained in the issuer's cardholder database, and responds back to the merchant with a verification indication such as, but not limited to, a “match”, a “no-match”, or a “not-available” response. EVM 121 can be accessed by merchants or other users at one of client systems 114 or POS terminals 115 by logging onto server system 112 through one of these computer systems 114 or 115.

System 100 also includes at least one input device 118, which is configured to communicate with at least one of POS terminal 115, client systems 114 and server system 112. In the exemplary embodiment, input device 118 is associated with or controlled by a cardholder making a purchase using a payment card account and payment card account system 100. Input device 118 is interconnected to the Internet through many interfaces including a network, such as a local area network (LAN) or a wide area network (WAN), dial-in-connections, cable modems, wireless modems, and special high-speed ISDN lines. Input device 118 could be any device capable of interconnecting to the Internet including a web-based phone, personal digital assistant (PDA), or other web-based connectable equipment. Input device 118 is configured to communicate with POS terminal 115 using various outputs including, for example, Bluetooth communication, radio frequency communication, near field communication, network-based communication, and the like.

In the example embodiment, one of client systems 114 may be associated with an acquirer while another one of client systems 114 may be associated with an issuer, POS terminal 115 may be associated with a merchant, input device may be associated with a cardholder, and server system 112 may be associated with the payment system network or the interchange network.

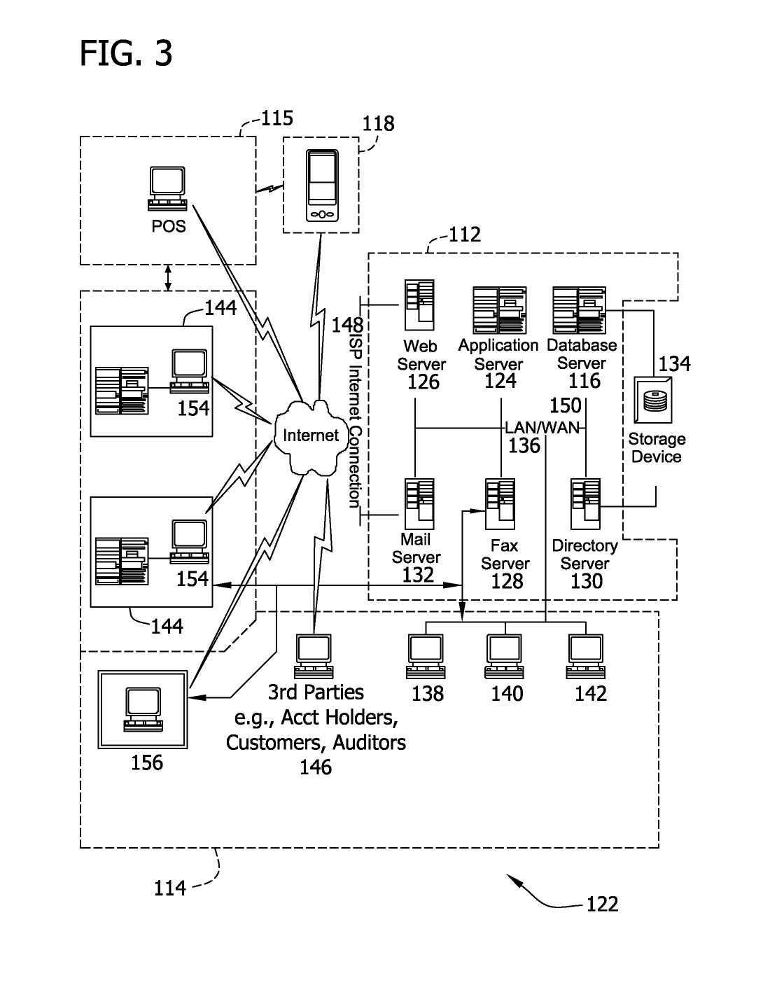

FIG. 3 is an expanded block diagram of an exemplary embodiment of a server architecture of a payment card account system 122 having an Ecommerce Verification Module (EVM) and offering an Ecommerce Verification Service (EVS) in accordance with one embodiment of the present invention. Components in system 122, identical to components of system 100 (shown in FIG. 2), are identified in FIG. 3 using the same reference numerals as used in FIG. 2. System 122 includes server system 112, client systems 114, POS terminals 115, and input devices 118. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a cardholder's workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, etc., 146 using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

In the example embodiment, transaction server 124 includes EVM 121 stored thereon for providing the EVS such that a merchant or other user is able to transmit cardholder information, directly or via an acquiring bank, to server system 112, which may be associated with an interchange network, for processing and transmitting to an issuer computer device 114; wherein the issuer verifies the transmitted cardholder information based on a comparison to information contained in the issuer's cardholder database, and responds back to the merchant with a verification indication such as, but not limited to, a “match”, a “no-match”, or a “not-available” response.

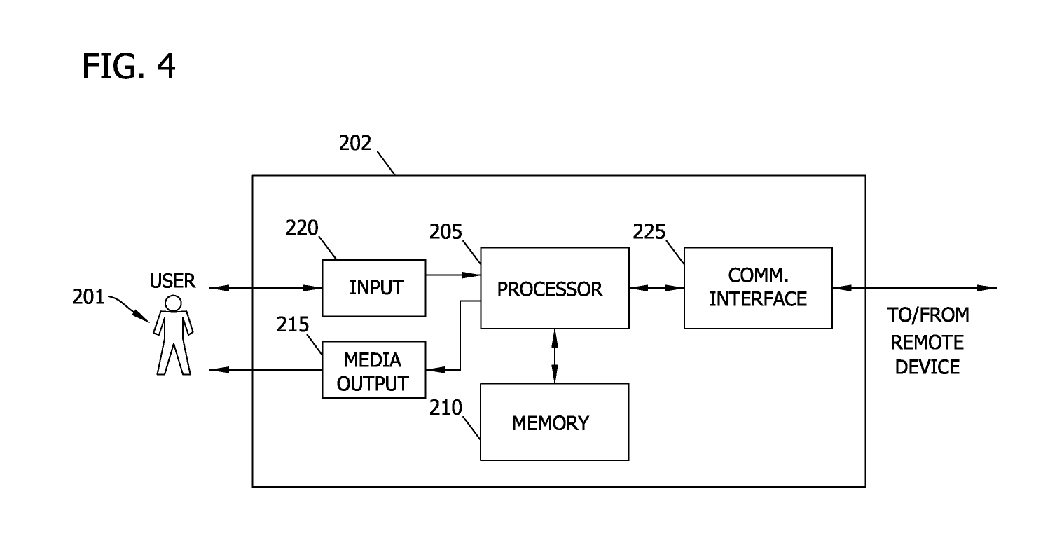

FIG. 4 illustrates an exemplary configuration of a cardholder's' computer device 202 operated by a cardholder's 201. Cardholder's computer device 202 may include, but is not limited to, client systems 114, 138, 140, and 142, POS terminal 115, input device 118, workstation 154, and manager workstation 156 (shown in FIG. 3).

Cardholder's computer device 202 includes a processor 205 for executing instructions. In some embodiments, executable instructions are stored in a memory area 210. Processor 205 may include one or more processing units (e.g., in a multi-core configuration). Memory area 210 is any device allowing information such as executable instructions and/or other data to be stored and retrieved. Memory area 210 may include one or more computer readable media.

Cardholder's computer device 202 also includes at least one media output component 215 for presenting information to cardholder's 201. Media output component 215 is any component capable of conveying information to cardholder's 201. In some embodiments, media output component 215 includes an output adapter such as a video adapter and/or an audio adapter. An output adapter is operatively coupled to processor 205 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, cardholder's computer device 202 includes an input device 220 for receiving input from cardholder's 201. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

Cardholder's computer device 202 may also include a communication interface 225, which is communicatively couplable to a remote device such as server system 112. Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 210 are, for example, computer readable instructions for providing a user interface to cardholder's 201 via media output component 215 and, optionally, receiving and processing input from input device 220. A user interface may include, among other possibilities, a web browser and client application. Web browsers enable cardholder's, such as cardholder's 201, to display and interact with media and other information typically embedded on a web page or a website from server system 112. A client application allows cardholder's 201 to interact with a server application from server system 112.

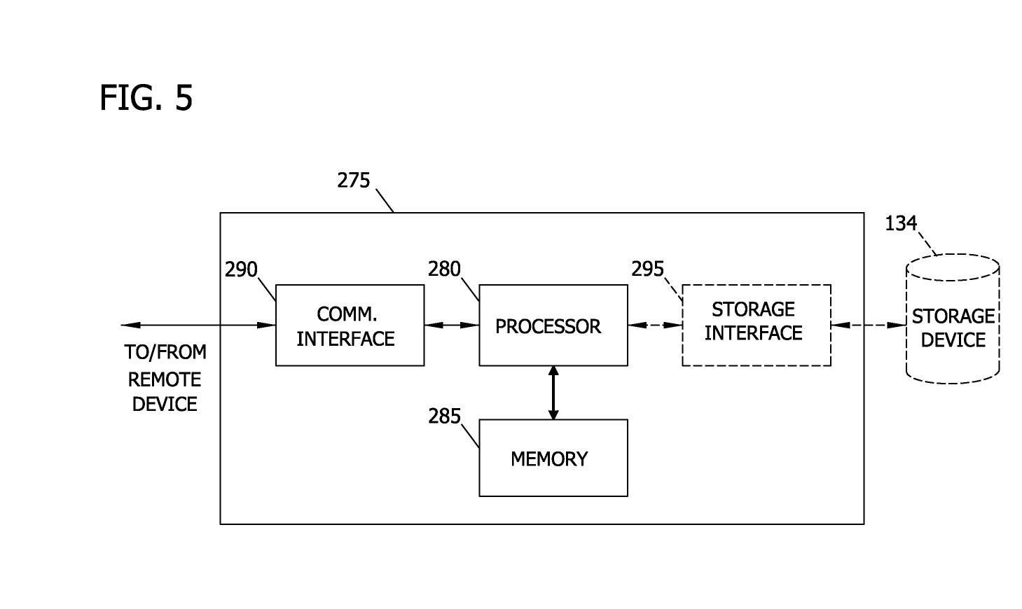

FIG. 5 illustrates an exemplary configuration of a server computer device 275 such as server system 112 (shown in FIGS. 2 and 3). Server computer device 275 may include, but is not limited to, database server 116, transaction server 124, web server 126, fax server 128, directory server 130, and mail server 132.

Server computer device 275 includes a processor 280 for executing instructions. Instructions may be stored in a memory area 285, for example. Processor 280 may include one or more processing units (e.g., in a multi-core configuration).

Processor 280 is operatively coupled to a communication interface 290 such that server computer device 275 is capable of communicating with a remote device such as cardholder's computer device 202 or another server computer device 275. For example, communication interface 290 may receive requests from client systems 114 or input device 118 via the Internet, as illustrated in FIGS. 2 and 3.

Processor 280 may also be operatively coupled to a storage device 134. Storage device 134 is any computer-operated hardware suitable for storing and/or retrieving data. In some embodiments, storage device 134 is integrated in server computer device 275. For example, server computer device 275 may include one or more hard disk drives as storage device 134. In other embodiments, storage device 134 is external to server computer device 275 and may be accessed by a plurality of server computer devices 275. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 280 is operatively coupled to storage device 134 via a storage interface 295. Storage interface 295 is any component capable of providing processor 280 with access to storage device 134. Storage interface 295 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 280 with access to storage device 134.

Memory areas 210 and 285 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

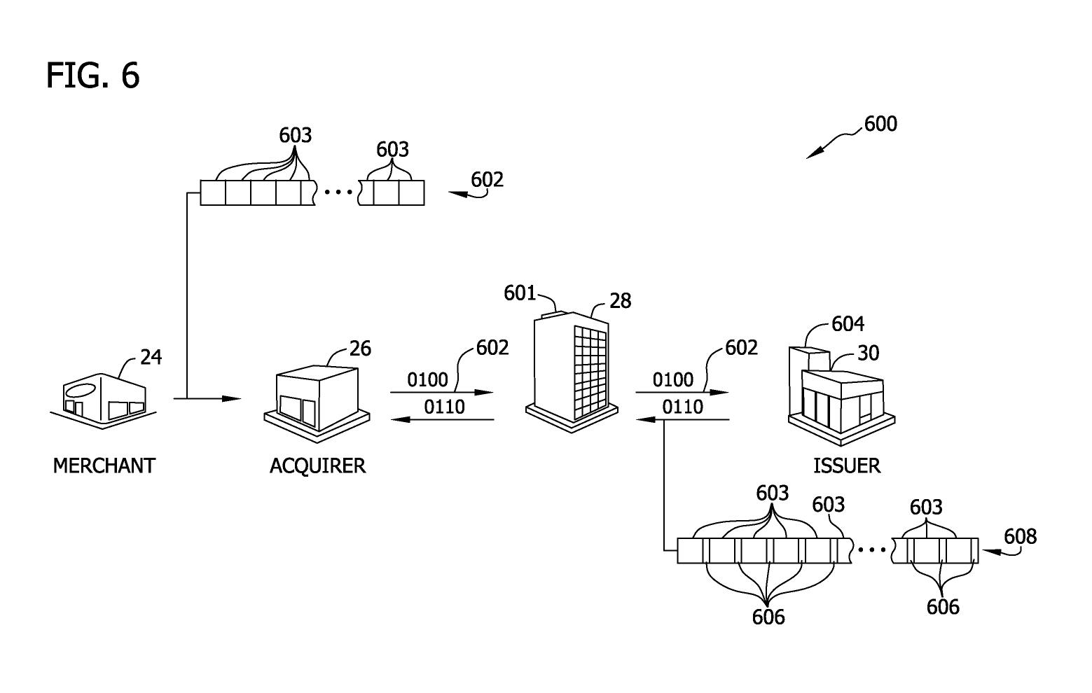

FIG. 6 is a simplified data flow block diagram of an exemplary payment card account system 600 having an Ecommerce Verification Module (EVM) 601 in accordance with one embodiment of the present invention that may be used with the payment card account systems shown in FIGS. 2 and 3. Through this system, merchant 24 requests issuer to validate cardholder information through network interface processor 28. Merchant 24 transmits cardholder information to issuer 30, issuer 30 verifies the transmitted cardholder information with information contained in the issuer's cardholder database 604, and responds back to merchant 24 with a verification indication such as, but not limited to, a “match”, a “no-match”, or a “not-available” response.

Although described in conjunction with a CNP transaction, EVM 601 is also able to be used for card present transactions. Specifically, an example of a CNP transaction includes payment transactions that use transaction card information stored by a merchant, wherein the transaction card is not present for the actual transaction. For example, a health club member may wish to avoid mailing a monthly check for club membership dues. The member may instead register a transaction card, such as a credit card, a debit card, or a prepaid card, with the club, enabling the club to automatically charge the transaction card for the monthly dues on a particular day each month. In some such systems, merchant 24 stores an account number, an expiration date, and/or other information associated with the transaction card and/or cardholder. Other examples of CNP transactions include telephone initiated transactions, postal mail transactions, or ecommerce or Internet transactions where the merchant does not have transaction card information stored or available and the merchant may not have a prior relationship with the purchaser at all. In such cases, the merchant receives the transaction card information at the time of the transaction.

In the example embodiment, EVM 601 functions as part of a normal authorization of a transaction using network interface processor 28. However, payment card account system 600 may be used to verify information not associated with a current transaction. For example, a merchant may wish to verify data associated with a perspective customer or past customer. In one embodiment, merchant 24 may initiate a transaction authorization using a “$0.00” amount. In another embodiment, merchant 24 may initiate a transaction authorization using any transaction amount but, does not complete the transaction when the authorization response is returned to merchant 24. In various embodiments, EVM 601 functions as an enhanced service funded on a subscription basis and may not operate on all transactions, but rather, may function on only transactions received from subscribed merchants. In various other embodiments, EVM 601 only functions on a transaction-by-transaction basis as requested by any merchant 24 during the authorization request process. Specifically, merchant 24 transmits a card transaction authorization request message 602, which includes a plurality of data elements 603, to acquirer 26 and indicates the ecommerce verification service is also being requested. Merchant 24 populates the data elements 603 that are requested to be validated by issuer 30. Data elements 603 that merchant 24 transmits to issuer 30 for validation/verification include but are not limited to, cardholder name, cardholder phone number(s); including for example, a home phone number, a work phone number and/or a cell phone number, an email address, an IP address, a street address, a device ID, a ship-to address, a merchant risk assessment, and other data.

Acquirer 26 populates a CNP ecommerce verification service request indicator within card transaction authorization request message 602 and submits card transaction authorization request message 602 to network interface processor 28.

Network interface processor 28 identifies if the ecommerce verification service indicator is present, and validates that issuer 30 supports the ecommerce verification service. Card transaction authorization request message 602 is routed on to network interface processor 28.

Issuer 30 receives card transaction authorization request message 602, identifies the ecommerce verification service indicator is present and validates EVS data points by comparing information provided by merchant 24 with the issuer cardholder database 604. Issuer 30 appends a verification indication 606 to each of the data elements 603 provided by merchant 24 within a card transaction authorization request response message 608. Verification indication 606 includes for example, but not limited to “match”/“no match” or “not available.”

Network interface processor 28 routes card transaction authorization request response message 608 to acquirer 26, including a card issuer authorization decision and ecommerce verification service verification indications 606.

Acquirer 26 receives card transaction authorization request response message 608 with ecommerce verification service verification indications 606 provided by issuer 30. Acquirer 26 transmits card transaction authorization request response message 608 to merchant 24. Merchant 24 determines whether to complete the transaction based at least in part on the card issuer authorization decision and ecommerce verification service verification indications 606 included within card transaction authorization request response message 608.

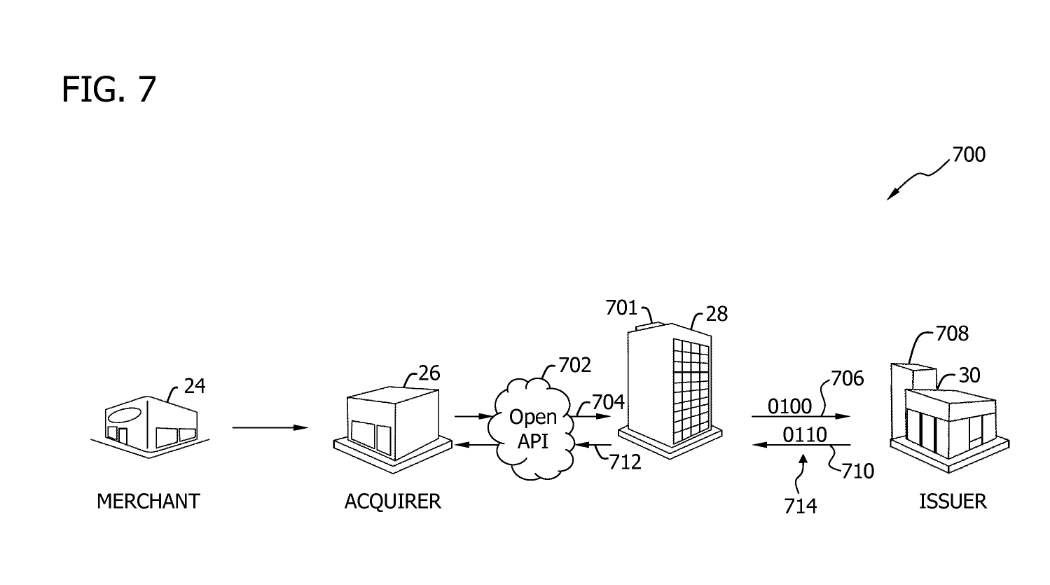

FIG. 7 is a simplified data flow block diagram of an alternative embodiment of a payment card account system 700 having an Ecommerce Verification Module (EVM) 701 that is accessible through an open application programming interface (Open API) 702.

In this alternative embodiment, at least one of merchant 24, acquirer 26 and other third parties (not shown) submit a web call request 704 to the network interface processor 28 (also referred to herein as the payment card account system) through Open API 702 associated with processor 28. By utilizing Open API 702, merchant 24, acquirer 26 and/or the other third parties are able to submit web call request 704 over a network, such as the Internet, to network interface processor 28. Network interface processor 28 is then able to convert web call request 704 into a card transaction authorization request message 706, which is then communicated to issuer 30 for data verification. The data verification is performed by issuer 30 by comparing information provided within web call request 704 to an issuer cardholder database 708. After performing the data verification, issuer 30 transmits a card transaction authorization response message 710 to network interface processor 28. Network interface processor 28 converts response message 710 into a web call response 712 that is sent by network interface processor 28 through Open API 702 to the party that originated web call request 704. The originating party is at least one of merchant 24, acquirer 26 and other third parties (not shown). Response message 710 and web call response 712 includes the data verified by issuer 30 and a verification indication such as, but not limited to, a “match”, a “no-match”, or a “not-available” response.

In this alternative embodiment, web call request 704 does not have to be part of a payment transaction being processed by network interface processor 28. Rather, web call request 704 can be a request submitted for any purposes where confirming the identity of a cardholder is important.

Specifically, merchant 24, acquirer 26 and/or any third party transmits web call request message 702, which includes a plurality of data elements. Message 702 indicates the ecommerce verification service is being requested. The data elements are requested to be validated by issuer 30. The data elements that merchant 24 (or acquirer 26 or other third party) transmits to issuer 30 for validation/verification include but are not limited to, cardholder name, cardholder phone number(s); including for example, a home phone number, a work phone number and/or a cell phone number, an email address, an IP address, a street address, a device ID, a ship-to address, a merchant risk assessment, and other data.

Network interface processor 28 receives web call message 702 through Open API 702 and identifies the message as having the ecommerce verification service indicator present, and validates that issuer 30 supports the ecommerce verification service. Network interface processor 28 converts web call request 704 into a card transaction authorization request message 706, which is then communicated to issuer 30 for data verification.

Issuer 30 receives card transaction authorization request message 706, identifies the ecommerce verification service indicator is present and validates EVS data points by comparing information provided by merchant 24 with the issuer cardholder database 708. Issuer 30 appends a verification indication 714 to each of the data elements provided by merchant 24 within a card transaction authorization request response message 710. Verification indication 714 includes for example, but not limited to “match”/“no match” or “not available.”

Network interface processor 28 converts response message 710 into a web call response 712 that is sent by network interface processor 28 through Open API 702 to the party that originated web call request 704. The originating party is at least one of merchant 24, acquirer 26 and other third parties (not shown). Response message 710 and web call response 712 includes the data verified by issuer 30 and verification indication 714 such as, but not limited to, a “match”, a “no-match”, or a “not-available” response.

Although described herein as the issuer performing the data verification, it is possible that other parties could perform the data verification. For example, in another embodiment, the payment card account system performs the data verification itself using data stored within a database associated with the payment card account system. In this embodiment, processor 28 would not have to transmit a data verification request to the issuer as part of an authorization request message, but rather, would perform the data verification functions itself. In another embodiment, the payment card account system would transmit the data verification request message to a third party, other than the issuer (e.g., credit rating entity), for data verification. Such a third party would be a party that stores information relating to cardholders. In either of these embodiments, the payment card account system or the third party would verify the information provided by the merchant or other party with a verification indication such as, but not limited to, a “match”, a “no-match”, or a “not-available” response.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processors 205, 280 including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect is verifying by the issuer certain data elements known to the merchant or acquired by the merchant during the transaction. The merchant requests the verification service be performed and supplies the particular data to be verified. The issuer searches its databases in an attempt to verify the data elements requested by the merchant. The issuer indicates whether the issuer was able to find a match, did not find a match, or could not perform the verification by appending an indicator to the response message and returns the indicator and an authorization decision to the merchant. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of a method and system of verifying certain data elements, selected by a merchant, by a transaction card issuer for payment card transactions, including card-not-present transactions using a network interface processor provides a cost-effective, secure, and reliable means for providing to a an increased level of fraud risk avoidance to merchants using card-present and card-not-present transactions.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer system for fraud detection in a payment card transaction system, the computer system comprising:
a memory device for storing data; and
a fraud detection computer system comprising a processor, the processor in communication with the memory device, said computer system programmed to:
receive a card transaction authorization request message for a payment card transaction initiated with a merchant, the card transaction authorization request message including a plurality of data elements to be verified and a verification request indicator;
determine whether the verification request indicator is valid;
transmit the card transaction authorization request message and verification request indicator to an issuer associated with the payment card used in the transaction;
receive a card transaction authorization response message from the issuer, the card transaction authorization response message including an issuer authorization decision and a verification indicator associated with each data element verified by the issuer, the verification indicator indicating a status of a verification of the data element with data stored in one or more databases of the issuer; and
transmit the card transaction authorization response message to the merchant.

2. A computer system in accordance with claim 1, wherein said card transaction authorization request message is received from the merchant through an acquirer, and wherein the merchant transmits the card transaction authorization request message to the acquirer with the plurality of data elements to be verified and a verification request message, and the acquirer populates said card transaction authorization request message with said verification request indicator.

3. A computer system in accordance with claim 1, wherein the card transaction authorization response message includes each of the plurality of data elements being verified along with one of the verification indicators provided by the issuer, wherein each of the verification indicators shows whether the issuer has independently verified the corresponding data element of the plurality of data elements using data stored in one or more databases of the issuer.

4. A computer system in accordance with claim 1, wherein each of said verification indicators comprises a determination of at least one of a match of the transmitted data element with a respective data element stored in the one or more databases of the issuer, a no-match of the transmitted data element with a respective data element stored in the one or more databases of the issuer, and a not-available response.

5. A computer system in accordance with claim 1, wherein said computer system is further programmed to receive a card transaction authorization request message for a card-not-present transaction.

6. A computer system in accordance with claim 1, wherein said plurality of data elements to be verified comprises at least one of a cardholder name, a cardholder home phone number, a cardholder work phone number, a cardholder mobile phone number, a cardholder email address, a cardholder IP address, a cardholder street address, a cardholder device ID, a ship-to address, and a merchant risk assessment.

7. A computer system in accordance with claim 1, wherein said computer system receives the card transaction authorization request message from the merchant, wherein the merchant transmits the plurality of data elements to be verified by the issuer.

8. A computer system in accordance with claim 1, wherein said computer system is associated with an interchange network, and the card transaction authorization request message is submitted as part of a transaction authorization process.

9. A computer system in accordance with claim 1, wherein the card transaction authorization request message comprises a web call request message that is received by said computer system over a wide-area network through an open application programming interface.

10. A computer system in accordance with claim 1, wherein said computer system is programmed to receive a card transaction authorization request message for a payment card transaction as part of a fraud detection verification service, and wherein said computer system is programmed to determine whether the verification request indicator is valid by determining that the verification request is present within the card transaction authorization request message, and that the corresponding issuer supports the fraud detection verification service.

11. A method of detecting fraud in a payment card transaction using a fraud detection computing device in communication with a memory device, said method comprising:
receiving, at the fraud detection computing device, a card transaction authorization request message for a payment card transaction initiated with a merchant, the card transaction authorization request message including a plurality of data elements to be verified and a verification request indicator;
determining whether the verification request indicator is valid;
transmitting the card transaction authorization request message and verification request indicator to an issuer computing device, the issuer computing device associated with an issuer bank having issued the payment card used in the transaction;
receiving a card transaction authorization response message from the issuer computing device, the card transaction authorization response message including an issuer authorization decision and a verification indicator associated with each data element verified by the issuer, the verification indicator indicating a status of a verification of the data element with data stored in one or more databases of the issuer; and
transmitting the card transaction authorization response message to the merchant.

12. A method in accordance with claim 11 wherein receiving a card transaction authorization request message further comprises receiving, at the fraud detection computing device, the card transaction authorization request message from the merchant through an acquirer, the merchant transmitting the card transaction authorization request message to the acquirer with the plurality of data elements to be verified and a verification request message, and the acquirer populating the card transaction authorization request message with the verification request indicator.

13. A method in accordance with claim 11 wherein receiving a card transaction authorization response message further comprises receiving the card transaction authorization response message from the issuer computing device, wherein the card transaction authorization response message includes each of the plurality of data elements being verified along with one of the verification indicators provided by the issuer, and wherein each of the verification indicators shows whether the issuer has independently verified the corresponding data element of the plurality of data elements using data stored in one or more databases of the issuer.

14. A method in accordance with claim 11 wherein receiving a card transaction authorization response message further comprises receiving the card transaction authorization response message from the issuer computing device, wherein each of said verification indicators includes a determination of at least one of a match of the transmitted data element with a respective data element stored in the one or more databases of the issuer, a no-match of the transmitted data element with a respective data element stored in the one or more databases of the issuer, and a not-available response.

15. A method in accordance with claim 11 wherein receiving a card transaction authorization request message further comprises receiving the card transaction authorization request message for a card-not-present transaction.

16. A method in accordance with claim 11 wherein receiving a card transaction authorization request message further comprises receiving the card transaction authorization request message including a plurality of data elements to be verified, wherein said plurality of data elements to be verified includes at least one of a cardholder name, a cardholder home phone number, a cardholder work phone number, a cardholder mobile phone number, a cardholder email address, a cardholder IP address, a cardholder street address, a cardholder device ID, a ship-to address, and a merchant risk assessment.

17. A method in accordance with claim 11 wherein receiving a card transaction authorization request message further comprises receiving the card transaction authorization request message from the merchant, wherein the merchant transmits the plurality of data elements to be verified by the issuer.

18. A method in accordance with claim 11 wherein the fraud detection computing device is associated with an interchange network, and the card transaction authorization request message is submitted as part of a transaction authorization process.

19. A method in accordance with claim 11 wherein receiving a card transaction authorization request message further comprises receiving a web call request message at the fraud detection computing device via a wide-area network and an open application programming interface.

20. A method in accordance with claim 11 further comprising:
receiving the card transaction authorization request message for a payment card transaction as part of a fraud detection verification service; and determining whether the verification request indicator is valid by determining that the verification request is present within the card transaction authorization request message, and that the corresponding issuer supports the fraud detection verification service.

21. At least one non-transitory computer-readable storage media having computer-executable instructions embodied thereon, wherein when executed by at least one processor, the computer-executable instructions cause the processor to:
receive a card transaction authorization request message for a payment card transaction initiated with a merchant, the card transaction authorization request message including a plurality of data elements to be verified and a verification request indicator;
determine whether the verification request indicator is valid;
transmit the card transaction authorization request message and verification request indicator to an issuer associated with the payment card used in the transaction;
receive a card transaction authorization response message from the issuer, the card transaction authorization response message including an issuer authorization decision and a verification indicator associated with each data element verified by the issuer, the verification indicator indicating a status of a verification of the data element with data stored in one or more databases of the issuer; and
transmit the card transaction authorization response message to the merchant.

22. The computer-readable storage media of claim 21, wherein the computer-executable instructions further cause the processor to receive the card transaction authorization request message from the merchant through an acquirer, and wherein the merchant transmits the card transaction authorization request message to the acquirer with the plurality of data elements to be verified and a verification request message, and the acquirer populates said card transaction authorization request message with said verification request indicator.

23. The computer-readable storage media of claim 21, wherein the computer-executable instructions further cause the processor to receive the card transaction authorization response message from the issuer, wherein the card transaction authorization response message includes a verification indicator associated with each data element verified by the issuer, and wherein each of the verification indicators comprise a determination of at least one of a match of the transmitted data element with a respective data element stored in the one or more databases of the issuer, a no-match of the transmitted data element with a respective data element stored in the one or more databases of the issuer, and a not-available response.

24. The computer-readable storage media of claim 21, wherein the computer-executable instructions further cause the processor to receive the card transaction authorization request message including a plurality of data elements to be verified, wherein the plurality of data elements to be verified comprises at least one of a cardholder name, a cardholder home phone number, a cardholder work phone number, a cardholder mobile phone number, a cardholder email address, a cardholder IP address, a cardholder street address, a cardholder device ID, a ship-to address, and a merchant risk assessment.
